(19) United States
(12) Patent Application Publication
(10) Pub. No.: US 2004/0097267 A1
(43) Pub. Date: May 20, 2004

(54) Method and apparatus for virtual bearer

(76) Inventors: Mark E. Pecen, Palatine, IL (US); Niels Peter Skov Andersen, Roskilde (DK); Ilya Gonorovsky, East Brunswick, NJ (US); Stephen A. Howell, Gloucester (GB); Arnold Sheynman, Northbrook, IL (US)

Correspondence Address: MOTOROLA INC, 600 NORTH US HIGHWAY 45, ROOM AS437, LIBERTYVILLE, IL, 60048-5343, US

(21) Appl. No.: 10/712,636

(22) Filed: Nov. 13, 2003

Related U.S. Application Data
(63) Continuation-in-part of application No. 10/358,864, filed on Feb. 5, 2003.
(60) Provisional application No. 60/427,190, filed on Nov. 18, 2002.
(60) Provisional application No. 60/427,108, filed on Nov. 18, 2002.

(51) Int. Cl. H04M 1/00; H04B 1/38

(52) U.S. Cl. 455/560; 455/452.2

(57) ABSTRACT

A mobile communication device, and a method of operating a mobile communication device, includes storing at least one frame of a communication signal received from a network, and applying flow control to the lower layers to support network reselection. According to one aspect of the invention, a message is transmitted indicating that a virtual bearer mode of operation is supported by the mobile communication device. The mobile communication device selectively operates in the virtual bearer mode depending upon the response received following such transmission. Additionally, flow control may advantageously be dependent upon detecting that a cell change is imminent.

### CROSS-REFERENCE TO RELATED APPLICATIONS

This application claims the benefit of U.S. Provisional Application No. 60/427,190, filed on 18 Nov. 2002, and entitled METHOD AND APPARATUS FOR PREDICTING A CELL CHANGE, and U.S. Provisional Application No. 60/427,108, filed on 18 Nov. 2002, and entitled METHOD AND APPARATUS FOR VIRTUAL BEARER, and the present application is Continuation-in-Part of U.S. patent application Ser. No. 10/358,864, filed on 5 Feb. 2003, and entitled NETWORK ASSISTED CELL RESELECTION IN WIRELESS COMMUNICATIONS SYSTEMS AND METHODS, by Mark Pecen et al., the disclosure of which is incorporated herein by reference thereto.

### FIELD OF THE INVENTION

The present invention pertains to wireless data communications, and more particularly to a method and apparatus for enhancing wireless communications.

### BACKGROUND OF THE INVENTION

The General Packet Radio Service (GPRS) and Enhanced Data for Global Evolution (EDGE) for the Global System for Mobile Communication (GSM) have introduced the capability of user data interchange into mobile wireless products. GPRS, and its superset, EDGE, permit efficient use of radio and network resources when data transmission characteristics are i) packet based, ii) intermittent and non-periodic, iii) possibly frequent, with small transfers of data, e.g. less than 500 octets, or iv) possibly infrequent, with large transfers of data, e.g. more than several hundred kilobytes. User applications were originally envisioned to include Internet browsers, electronic mail, file transfers and other applications for which “best efforts” data transfer are appropriate.

The original GPRS and EDGE specification, appearing initially in releases R97 and R99 respectively (hereinafter collectively referred to as R97/R99), added best efforts user packet data service to the pre-existing GSM voice service. Since GSM provided no notion of user packet data service at its inception, the original GPRS and EDGE offerings of R97/R99 were designed to operate within an architectural environment optimized to the provision of voice service, which severely restricted the capabilities and extensibility of these services. These restrictions were felt to be a reasonable compromise that allowed the introduction of a new service while reducing impact on the existing architecture and/or GSM legacy services.

FIG. 1 shows the fundamental GPRS/EDGE data plane system architecture as per Release R97/R99. In general, a mobile 101 communicates with a base station controller (BSC) 106 via one of the base stations 103-105. The base station controller communicates with the circuit switch (CS) domain via interface A and the packet switch (PS) domain via interface Gb.

The original GSM domain was the circuit switched domain, over which voice traffic is routed between the radio subsystem, represented by the Base Station Controller 106 (FIG. 1) and Base Transceiver Stations (BTS) 103-105, and the Public Switched Telephone Network (PSTN) 108 via the A interface to the Mobile Switching Center (MSC) 110. The packet switch domain is routed through a Protocol Control Unit (PCU) 112 which is a “convergence” component, and contains a Radio Link Controller (RLC) and a Medium Access Control (MAC) layer (not shown) over which packet data is routed via a 2G gateway GPRS Support Node (GGSN) 114 and a border gateway 118 connected to the packet data network 120. The packet data network may for example be the Internet or a private data network.

With very few exceptions, there is as little coordination as possible between the circuit switched and packet switched domains. In addition, the original R97/R99 specifications do not support multiple packet data flows, Quality of Service (QoS) control, real time data transfer or packet switch domain “true handover” between cells and/or network domains.

For GPRS, there is no procedure defined which is equivalent to the handover procedure used for circuit switched GSM voice and data calls. Instead “break-before-make” reselection is used to support the mobile station mobility during the mode when a Temporary Block Flow (TBF) is established. As a consequence, the input data flow is interrupted every time a cell reselection is performed.

More particularly, the mobile station, being in GPRS Standby and Ready states, may perform cell reselection. The cells to be monitored for cell reselection are defined in the Broadcast Allocation (BA) list, which is broadcast on PBCCH or BCCH if PBCCH does not exist. In packet transfer mode, the mobile station continuously monitors the carrier of the serving cell and all BCCH carriers as indicated by the BA list (neighbor cells). In every TDMA frame a received signal level measurement sample is taken on at least one of the BCCH carriers, one after another.

For reselection decision making, the received signal level average (noted as RLA_P) is calculated as a running average of samples collected over a period of 5 seconds and is maintained for each BCCH carrier. The samples allocated to each carrier are as far as possible uniformly distributed over the evaluation period. At least 5 received signal level measurement samples are required for a valid RLA_P value.

According to the GSM standard, the following cell reselection criteria (measured in dBm) are used for GPRS.

a. The path loss criterion parameter C1 (3GPP TS 05.08, 6.4) is used as a minimum signal level criterion for cell reselection for GPRS in the same way as for GSM Idle mode. The C1 calculation for each cell (serving and neighbour) is based on the corresponding RLA_P value.

b. The cell ranking criterion parameter C32 (3GPP TS 05.08, 6.4) is used to select cells among those with the same priority. For serving cell, C32 is equal to corresponding C1. For each neighbour cell, C32 is equal to corresponding C1 modified with cell broadcast parameters.

c. The signal level threshold criterion parameter C31 (3GPP TS 05.08, 6.4) for hierarchical cell structures (HCS) is used to evaluate prioritised hierarchical GPRS.

At least for every new sample or every second, whichever is the greatest, the mobile updates RLA_P and calculates the value of C1, C31 and C32 for the serving cell and the non-serving (neighbor) cells. The mobile station makes a cell reselection if:

i) The path loss criterion parameter C1 for the serving cell falls below zero.

ii) A non-serving suitable cell (see 3GPP TS 03.22) is evaluated to be better than the serving cell.

The best cell is the cell with the highest value of C32.

When evaluating the best cell, the hysteresis values are subtracted from the C32 value for the neighbor cells. The hysteresis values are broadcast on PBCCH of the serving cell. In case when a cell reselection occurred within the previous 15 seconds, the hysteresis value equals to 5 dB. If no suitable cell is found within 10 seconds, the cell selection algorithm of 3GPP TS 03.22 is performed.

As a consequence of this break-before-make operation, GPRS/EDGE is limited to interruption tolerant data modes. However, it would be desirable to accommodate improved handover of packet switch services so as to support more data throughput modes and greater versatility without major modifications of existing systems.

### BRIEF DESCRIPTION OF THE DRAWINGS

The present invention and the corresponding advantages and features provided thereby will be best understood and appreciated upon review of the following detailed description of the invention, taken in conjunction with the following drawings, wherein like numerals represent like elements, in which:

FIG. 1 is a schematic representation of a wireless cellular system.

FIG. 2 is circuit schematic in block diagram form of a mobile communication device coupled to a BTS.

FIG. 3 is block diagram illustrating the software architecture of a mobile communication device.

FIG. 4 is block diagram illustrating a portion of the mobile communication device according to FIG. 3.

FIG. 5 is a state diagram illustrating a mobile communication device operating states.

FIG. 6 is a state diagram illustrating TBF ON and OFF state transitions.

FIG. 7 is a state diagram illustrating a virtual bearer queue input state transitions.

FIG. 8 is a state diagram illustrating a virtual bearer queue output state transitions.

FIG. 9 is a block diagram illustrating a virtual bearer control.

FIGS. 10a and 10b are flow charts illustrating operation of a mobile and a network.

FIG. 11 is a block diagram illustrating an alternate embodiment of a portion of the software architecture according to FIG. 3.

FIG. 12 is a schematic representation illustrating a mobile moving through cells of a cellular system.

FIG. 13 is a schematic representation of cell change control in a mobile communication device.

FIG. 14 is a block diagram further illustrating cell change control for a mobile communication device.

FIG. 15 is a representation of reselection measurements for a predictor.

FIG. 16 is a representation of reselection criteria for the predictor.

### DETAILED DESCRIPTION OF THE DRAWINGS

A mobile communication device, and a method of operating a mobile communication device, includes storing at least one frame of a communication signal received from a network, and applying flow control to the lower layers to support network reselection. Lower layers are those layers below the virtual bearer. According to one aspect of the invention, a message is transmitted to the network indicating that the mobile communication device supports a virtual bearer mode of operation. The mobile communication device selectively operates in the virtual bearer mode depending upon the response received following such transmission. Additionally, flow control through the virtual network may advantageously be dependent upon detecting that a cell change is imminent. In this manner, interruption intolerant data modes can be readily accommodated with minor modification to the existing system.

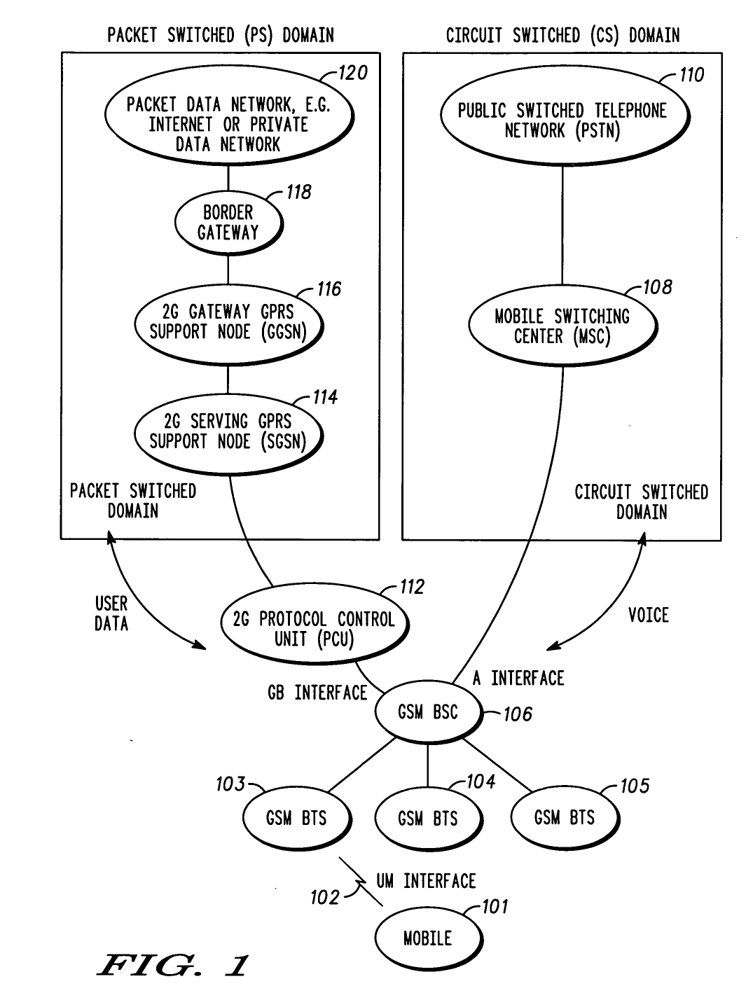

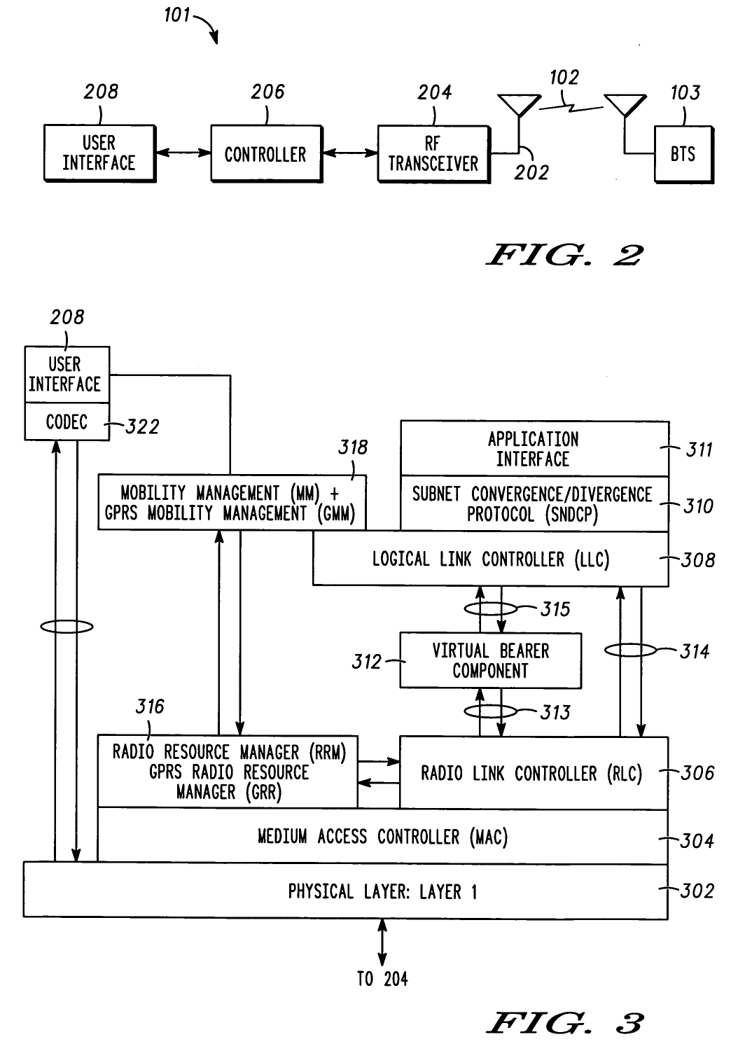

A wireless communication device 101 (FIG. 2), also referred to as user equipment, a mobile or a mobile station, may be a fixed or portable cellular radio, a personal digital assistant (PDA), a modem operating with a personal computer, or any other device operating in the wireless communication system such as the exemplary GSM system of FIG. 1. The communication device includes an antenna 202, a radio frequency (RF) transceiver 204, a controller 206, and a user interface 208. The antenna 202 may be implemented using any suitable antenna. The transceiver 204 may be integrated with, or separate from, the controller 206, and may be implemented using any suitable wide area wireless interface communication circuitry, such as a hard ware or software implemented radio frequency (RF) cellular transceiver. The controller 206 may include logic circuitry, memory, and software, and provides functionality for the communication device. It may be implemented using one or more of: a microprocessor; digital signal processor; micro-controller; programmable logic; or the like. The user interface 208 facilitates communication of information or controls, to and from the controller or transceiver. The user interface 208 can include any device interface, such as one or more of the following: a keypad; a transducer; a display; a local area connection such as infrared or radio frequency local connections, or the like; and a connector such as universal serial bus, an RS-232 connector, or the like.

The mobile station software architecture within the communication device controller 206 is represented in FIG. 3. The controller 206 of mobile 101 includes a physical layer 302 that interfaces with the radio frequency transceiver 204. The physical layer 302 schedules reception and transmission of physical data, performs receiver gain control, transmitter power control, signal level measurements, and other functions not described in greater detail herein. A medium access controller (MAC) 304 organizes the transmission and reception of packet-based information into and out of the physical layer interface 302. The medium access controller 304 primarily includes logic by which the mobile 101 is informed of the mobile's 101 right to transmit at a given time on the uplink and recognition of those messages addressed to mobile 101 on the downlink.

A radio link controller 306 controls the mobile station 101 with regard to network-oriented signaling pertaining to the radio messages, i.e., timeslot assignments, packet data channel setups/teardowns, RF channel assignments, and other functions not described in greater detail herein, in addition to passing messages originating from the network and communicated via physical layer interface 302. The radio link controller 306 is primarily involved with error correction at the radio layer, i.e., to absorb the periodic errors which result from the fading channel, and also handles certain aspects of GPRS/EDGE data transfer setup and teardown. In this way, radio link controller 306 maintains the integrity of the radio link through acknowledgements and re-transmissions.

For packet data, the logical link controller (LLC) 308 packetizes, or divides, network protocol packet data into radio packets for transmission over-the-air on radio frequency channel 102, and provides compression and encryption services. The subnetwork convergence/divergence protocol unit (SNDCP) 310 unpacketizes/divides radio packets received by mobile 101 to the network protocol packet data for transfer to an application interface 311 of mobile 101. The application interface exchanges the network protocol data between subnetwork convergence/divergence protocols to a corresponding application within mobile station 101. In this way, user or traffic packet data is transferred between an application interface and physical layer 302 through the subnetwork convergence/divergence protocol 310 the logical link controller 308, radio link controller 306, and the medium access controller 304.

The controller 206 further includes a radio resource manager (RRM) and GPRS radio resource manager (GRR) 316 for managing intracell mobility and radio resource assignments. The mobility management (MM) and GPRS mobility management (GMM) layer 318 manages intercell mobility.

The voice path for digitized speech is through the physical layer 302 and a CODEC 322. The CODEC receives input speech from the user interface for transmission on the uplink, and outputs speech received from the downlink to user interface 208 for reproduction through a speaker (not shown). It can be seen that voice and packetized data are processed though separate paths in the mobile 101, reflecting the different paths for the voice and packetized data traffic in the network, as shown in FIG. 1. This structure of the system permits the addition of GPRS/EDGE to the existing voice networks without detrimentally impacting the existing reliable GSM legacy voice systems.

A limitation of this existing system is that it does not support data communications that require uninterrupted connections, referred to herein as interruption intolerant communications. Examples of such communications are streaming video or music. This is because GPRS/EDGE uses “break before make” reselection to support mobile station reselection, establishing a temporary block flow (TBF), as is known to those skilled in the art. As a consequence, input data flow is interrupted each time a cell reselection is performed.

In order to accommodate interruption intolerant data transmissions to the mobile 101 with minimum impact on the existing GPRS/EDGE system, a virtual bearer 312 is inserted in the mobile 101. Those skilled in the art will recognize that the downlink, that is the path from the network to the mobile, is the principle link subject to such communications, and thus the virtual bearer is described with reference to the downlink. However, it will be recognized that the virtual bearer may find application in the uplink as well. The exemplary virtual bearer 312 is inserted between the logical link controller 306 and the radio logic link 308. The virtual bearer 312 stores downlink data from the radio link controller for later input to the logical link controller 308 and thereafter for use by applications of the mobile 101. By inserting the virtual downlink bearer component logically above the radio link controller 306 layer and below the logical link controller 308 layer, the virtual bearer operates on assembled logical link controller frames on the receiving side. The function of the virtual streaming downlink bearer 312 is to store downlink data when the downlink is not interrupted, and then to provide the stored data to the logical link controller when the downlink flow is interrupted. In this manner, the virtual bearer continues the provision of data to the logical link controller until a connection is restored.

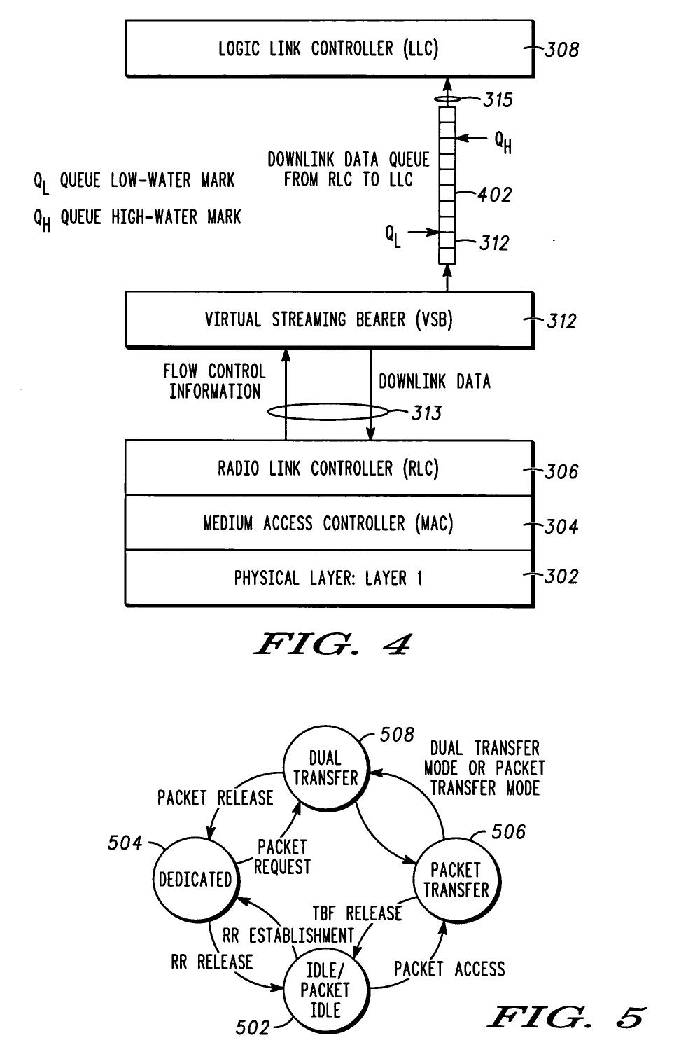

The virtual bearer 312 will now be described in greater detail, beginning with reference to FIG. 4. In a first embodiment, which is an extension of the existing GPRS/EDGE general architecture, a single new virtual bearer 312, e.g. the virtual streaming bearer, is inserted into the mobile 101 between the Logical Link Controller (LLC) 308 and Radio Link Controller (RLC) 306 by way of interfaces 313, 315. The illustrated virtual bearer 312 receives downlink data, and loads it into a queue 402. The output signal from the queue is input into the logical link controller 308 via interface 315. In general, for a streaming bearer, the queue input controls the insertion of data into the queue to i) ensure that the downlink data queue is filled to a sufficient degree before sending any data to the logical link controller and ii) maintain the queue data at a sufficient level whenever data are received.

The virtual bearer queue 402 can be controlled by manipulating (separately or in combination) two of the following parameters:

Input/Output data rate ratio; and

virtual bearer queue size (low-water mark and/or high-water mark).

Those skilled in the art will recognize that by controlling these parameters, the cell reselection can be accommodated without loss of streaming data, even when the downlink is interrupted.

Still more particularly, the following variables will be used to describe the operation of the virtual bearer:

| | |
|---|---|
| Ton: | Temporary Block Flow ON: in this state, a packet data transfer is |
| | occurring; |
| Toff: | Temporary Block Flow OFF; There is no packet data transfer, or |
| | temporary block flow, occurring in this state, but the “Ready |
| | Timer” is running, permitting rapid return to packet transfer |
| | operation before it expires; |
| I | IDLE: packet idle mode. There is no temporary block flow and |
| | the Ready Timer has expired. In order to obtain a TEMPORARY |
| | BLOCK FLOW, a full setup is required; |
| A | TEMPORARY BLOCK FLOW Started. There is an active packet |
| | data transfer; |
| Rs | Ready timer started; |
| Rx | Ready time expired; |
| Rc | Ready timer cleared; |
| F | Downlink data flow turned on from RLC; |
| QLL | Data in downlink data queue < queue low water mark QL; |
| QHH | Data in downlink data queue > queue high water mark QH; and |
| S | Send frame to LLC. |

In operation, it is assumed that the virtual bearer is activated, or awakened, each time that the radio link controller has a fully assembled logical link controller frame to deliver. Each time the VSB process awakens, it follows the following set of rules for controlling its execution:

Determine the state of RR/GRR: If not in packet transfer state Ton, then there is no automata operation required. Additionally, make note of last GRR state, so that (I<->Ton) may be tested the very next time that Ton EQ TRUE.

IF GRR state Ton EQ TRUE

IF (I<->Ton) EQ TRUE

Set a variable VSB_Reset=TRUE

FI

<Execute input queue automaton>

<Execute output queue automaton>

FI

The Virtual Streaming Bearer (VSB) logic comprises three state automata:

1) In the GSM specification radio resource state transition, a sub-state is added which is based on whether or not the “ready timer” is running when in Packet Transfer or Dual Transfer Mode. This may be referred to as the Primary Control Automaton.

2) The Queue Input Automaton, controls data input to the downlink data queue by controlling the flow over the radio medium.

3) The Queue Output Automaton, which controls the output from the downlink data queue to the LLC layer.

The operation is controlled to maintain the downlink data queue to a sufficient level so as i) to minimize the impact on jitter, resulting from momentary variations in transfer rate due to scheduling, re-transmissions etc., and ii) to reduce the impact of cell reselection on the continuity of downlink data flow.

Additionally, the placement of the virtual bearer component above radio link controller further reduces its impact on the existing components by permitting reuse of the temporary block establishment logic in the radio link controller. That is, even if the radio link controller is operated in transparent mode, it is still in charge of initiating the signaling required to start and manage the temporary block flow.

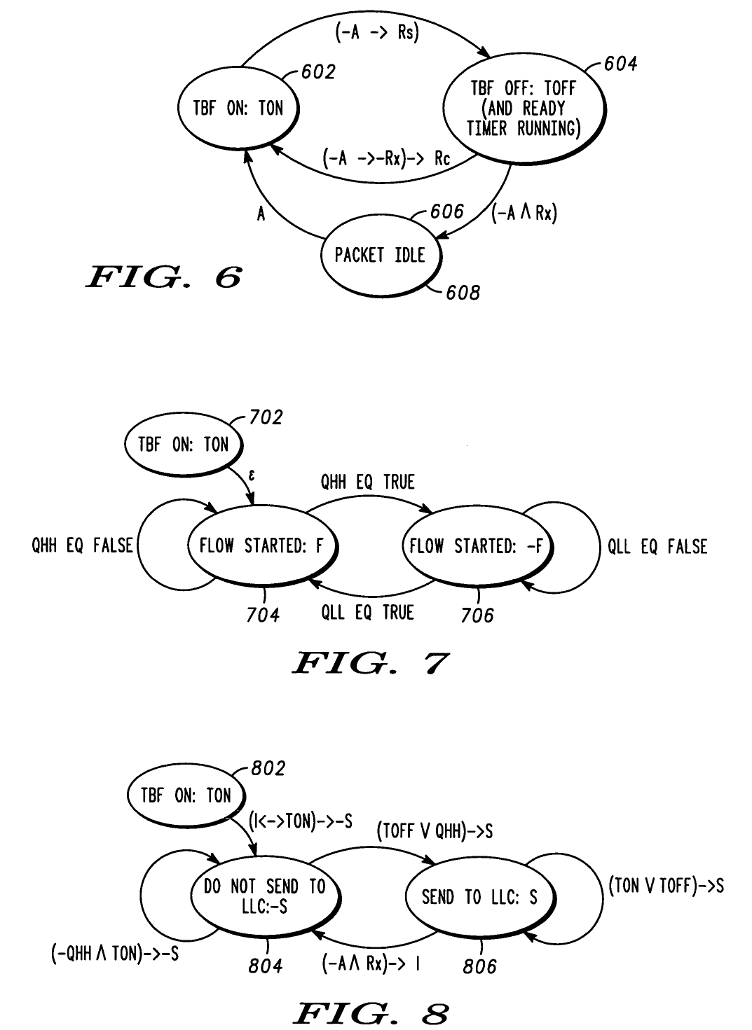

The master states will now be described with respect to GPRS/EDGE GSM terminology and reference to FIGS. 5 and 6. The states are controlled as follows. The phone operates in idle/idle packet mode 502 when no communications occur. A dedicated mode 504 is entered when a radio resource is allocated, and terminates when the radio resource is released. The packet transfer mode 506 is entered when packet access is initiated, and terminated when a temporary block flow is terminated. Dual transfer mode 508 occurs where there is simultaneous voice and packet data communication.

With reference to FIG. 6, the TBF ON state 602 is the expressed condition when the mobile radio resource state is either in i) Dual Transfer Mode (DTM) AND has a temporary block flow is in progress, OR ii) in packet transfer mode only. In the state TBF OFF 604, ready timer running, is the condition in which the ready timer is running while the TBF is off, it being recognized that the ready timer is started whenever a temporary block flow normally terminates. In the case where there is no active temporary block flow, and the ready timer is running, a full signaling setup sequence is not required in order to start a new temporary block flow. State 606 represents an idle packet.

The input queue automation is represented in FIG. 7. Prior to initiation of a temporary block flow 702, downlink data is loaded into queue 402, and continues until the queue 402 is stuffed. The queue is loaded 704 until it reaches the designated queue high water mark (upper storage threshold which is the capacity limit for the queue). When it reaches this threshold, storage of data in the queue is stopped 706. Loading of the queue is halted until the queue reaches the queue low water mark (the storage threshold which is the minimum capacity for the queue). In this manner, the queue can be managed to remain between the upper and lower thresholds. This queue process will be effective for data communication types, such as streaming audio and video, that are delay sensitive (user can tolerate some delay before the data reaches the application), but interruption intolerant (once started interruptions will cause glitches).

It is envisioned that the virtual bearer can advantageously be controlled more intelligently. A virtual bearer queue state variable S is set to be a variable representing the virtual bearer queue occupancy (%). The value of S can be recursively defined at the any given moment of time (1+1) as follows:

Sᵢ₊₁=F(Sᵢ,Q_{L},Q_{H},R_{IO},F_{CR}),

where Q_{L} is a VSB queue low-water mark, Q_{H} is a VSB queue high-water mark, R_{IO} is an Input/Output data rates ratio, and F_{CR} is a frequency of randomly occurred cell reselections. The queue's output rate adjustment (control) period is referred to herein as T_{adj}. The output data rate at the end of each interval, i.e. set it for the next interval.

For any discreet control period of I, a trivial control policy will be to set the output data rate rₒᵤₜ (i+1) for the next interval that provides transmission to LLC layer the same amount of data that has arrived from the radio link controller in the previous period rᵢₙ(i). Thus output data rate for period (I+1) can be determined as

rₒᵤₜ(i+1)=rᵢₙ(i).

When the input stream data rate from the radio link controller increases, the virtual bearer queue may become full and requires flow control involvement. When the input stream data rate decreases, the logical link controller layer does not receive enough data, and the application “starves”. As a result, the user's quality of service perception could degrade.

According to an alternate embodiment, the above formula is modified to take into consideration the status of queue 402. In such case the output rate for the next period of time should be equal to the current content of the queue plus the same amount of data that has been received in the previous period. This means that:

$${r}_{out} ( i + 1 ) = {r}_{in} ( i ) + \frac{S ( i )}{{T}_{adj}} ,$$

where T_{adj} is the duration of the queue adjustment (control) period.

Regardless of which of the above embodiments is utilized, it will be recognized that there is a possibility that the queue 402 periodically empties during a cell reselection. There are three major reasons for this: (i) the length of a data stream interruption caused by reselection, (ii) the speed with which the application consumes data from the queue (more precisely, the ratio between queue input and output data rates), and (iii) the queue size (i.e. high water and low-water marks).

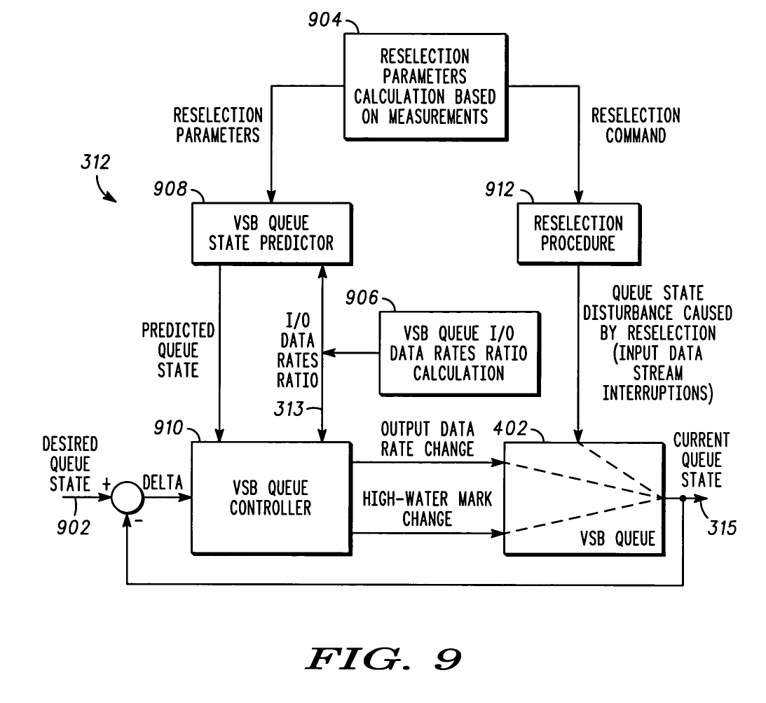

An alternate embodiment is illustrated in FIG. 9. For the virtual bearer queue, the control quality (control criteria) can be defined as an integral number of starvation occurrences during the session period. The goal of the control mechanism is to decrease (minimize) the control criteria compare to the “open loop system” with no control. The proposed system is a combined system where the closed loop control is used together with the prediction of the cell change. It is further envisioned that a predictor of randomly occurring cell reselections may also significantly increase the control quality.

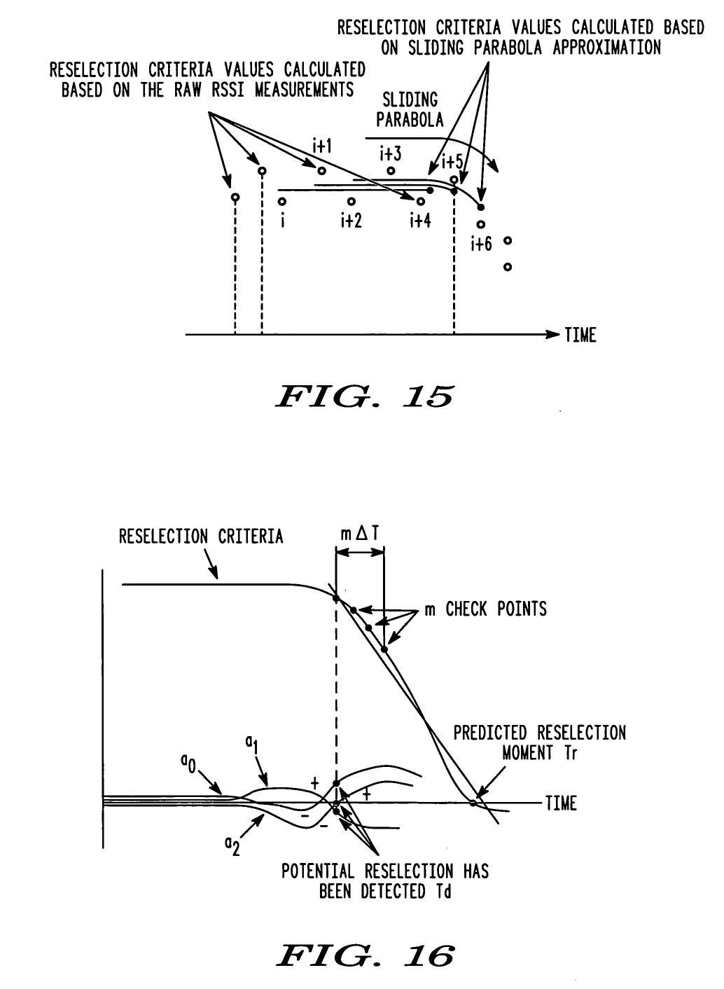

More particularly, the queue control loop for queue 402 is illustrated in FIG. 9. The virtual bearer queue 402 is controlled to maintain a desired queue state. The other input to the control loop is a reselection command generated by cell change controller (described with reference to FIGS. 15, 16) and reselection parameters generated by a reselection predictor 904 (also described with reference to FIGS. 15, 16). Additionally, the queue input/output (I/O) data rates ratio is calculated in block 906, which is the ratio of the rate at which the queue is loaded to the rate at which the queue is unloaded. The virtual bearer queue state predictor 908 predicts the queue state, and inputs this prediction to the queue state controller.

The controller can dynamically change the queue capacity depending upon the predicted need. Thus, where cell reselection is frequent, the upper threshold (high water mark) QH can be large. When cell reselection is infrequent, the upper threshold QH can be lowered, saving memory for other applications in the mobile and reducing the delay caused by the queue. It will be recognized that in operational environments, such as central London, even if the mobile station is physically stationary, the channel may not be. It is fairly common to see mobiles engaging in cell reselection every 10 seconds or so and bouncing within the same group of two or three cells, depending on system parameter settings (hysteresis and reselection timer). In such an environment, a very robust bearer will be required. Alternatively, in other environments, such as rural environments, cell reselection will be infrequent except at cell boarders. The present invention can accommodate both environments by providing the appropriate level of memory with using undue excess of resources and introducing undue delay.

Additionally, the queue controller 910 can adjust the output data rate to maintain the queue at a constant level as conditions change. Finally, the reselection component 912 controls the queue to operate in an interruption mode, where stored data is output uninterrupted during cell reselection. The control loop controls the queue so as to be held substantially constant. Additionally, the queue size can vary depending upon whether or not a cell reselection is anticipated.

The queue occupancy target Sₜₐᵣ is also specified, which is the queue occupancy that should be reached and sustained by the control system during the session. To increase the control quality, the system performs sampling inside each control period, measures input data rate, and maintains its running average:

$${\overline{r}}_{in} ( i ) = {\overline{r}}_{in} ( i - 1 ) + \frac{{r}_{in} ( i ) - {\overline{r}}_{in} ( i - 1 )}{i} , i = 1 , 2 , 3 … ; {\overline{r}}_{in} ( 0 ) = 0.$$

For each queue adjustment (control) period, the control algorithm works as follows:

Step 1: Set \overline{r}ᵢₙ(i) to zero at the beginning of the period of I

Step 2: Measure input data rate and maintain the running average \overline{r}ᵢₙ(i) during the current adjustment period of i.

Step 3: Determine the virtual bearer queue occupancy S(i) at the end of the adjustment period of i.

Step 4: Set the output data rate for the next control period (I+1) according to the following formula:

$${r}_{out} ( i + 1 ) = {\overline{r}}_{in} ( i ) + \frac{S ( i ) - {S}_{tar}}{{T}_{adj}} .$$

The running average \overline{r}ᵢₙ(i) is calculated based on the samples taken inside of the each control period. The running average \overline{r}ᵢₙ(i) is reset at the beginning of each queue adjustment period. This means that the status of the queue at the end of the adjustment interval depends on the queue state observed at the end of the previous control period and independent of the previous intervals.

In simulations, it has been determined that by running the input rate to the queue at no more than 20% greater than the queue output rate, cell reselection can occur. Loading rates less than 10% greater than the queue output rate in hostile reselection simulation were able to support unimpaired streaming signals at the mobile output.

According to an alternate embodiment, whenever the services of the virtual bearer are not used, it is envisioned that the radio link controller can be operated in a transparent mode. This is represented by bi-pass 314 in FIG. 3. For transmissions where the virtual bearer is needed, the virtual bearer can be employed. On the other hand, for conventional best efforts GPRS/EDGE transmissions, the virtual bearer is bi-passed. It is envisioned that this could be accomplished through an exchange between the network and the mobile.

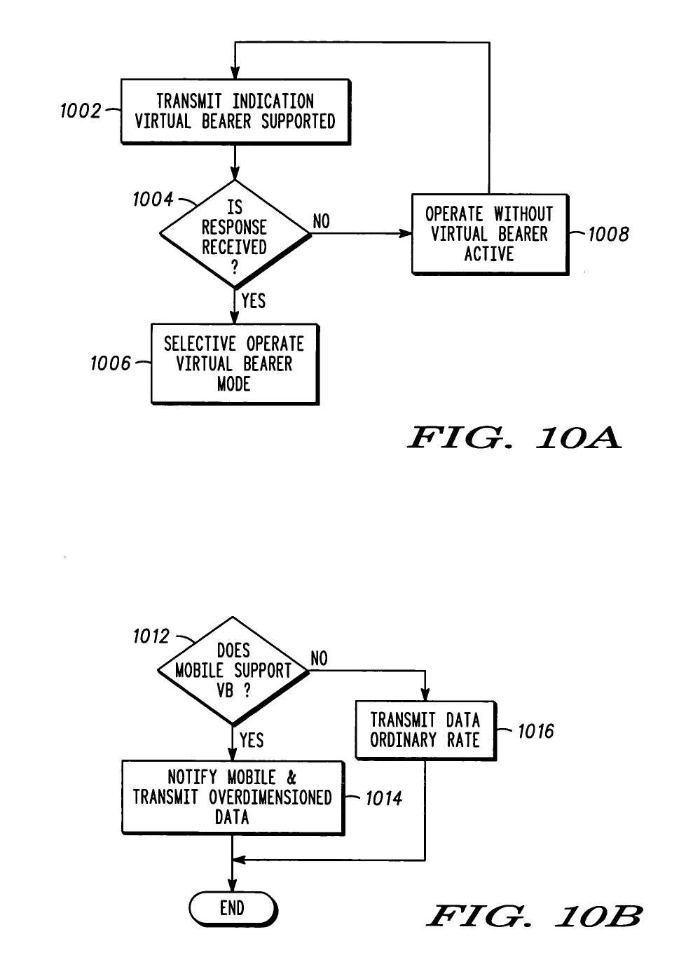

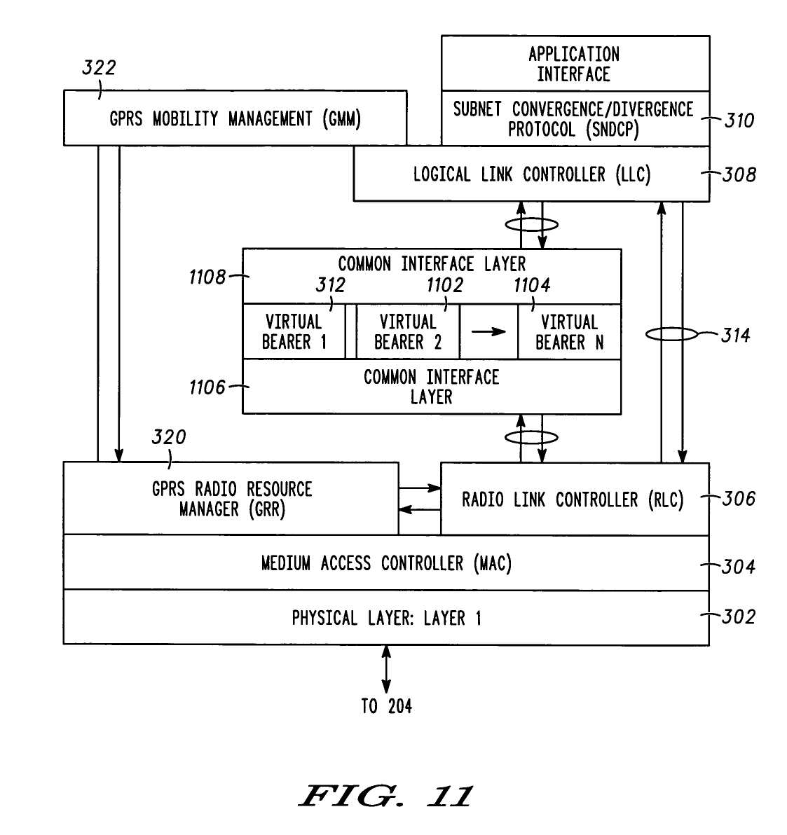

More particularly, the radio link controller 306 sends notification to the GPRS Radio Resource management (GRR) layer 316 that establishment is needed. According to one embodiment, the GRR can notify the network that virtual bearer operation is supported by the mobile 101, as represented by step 1002 in FIG. 10a. The mobile then waits for a response as indicated in step 1004. The network can respond to the notification, detected in step 1012 in FIG. 10b, by indicating virtual bearer operation will begin, as indicated step 1014 which illustrates notifying the mobile and intitiating over-dimensioned transmission. Such notification can include the virtual bearer type where multiple, different virtual bearers may exist. For example, the network can indicate that a streaming virtual bearer operation will be initiated, and it can initiate transmissions at a higher data rate (an over-dimensioned rate) to support stuffing the queue in preparation for cell reselection. The GPRS radio resource management can then notify the radio link controller when it may begin sending radio blocks to the Medium Access Control (MAC) layer. In addition, this architecture supports a transparent mode, which is a mode that bypasses the virtual bearer where conventional GPRS/EDGE packet data transmission is sufficient. In transparent mode, mobile and network operate as if the virtual bearer is not present when the virtual bearer is not needed. This mode can be the standard operation mode prior to receipt of acknowledgement from the network, as indicated in step 1008. When the virtual bearer is not active, the network transmits data at its ordinary data rate, as indicated in step 1016. Those skilled in the art will recognize that the GRR may operate to initiate the virtual mode independently of the network (i.e., without notifying the network), as an alternative to the negotiation between the network and the mobile described herein.

Yet another embodiment is illustrated in FIG. 11, wherein a multiple virtual bearer component 1100 is illustrated. The multiple virtual bearer includes multiple virtual bearers 312, 1102, 1104 coordinated by common interface layers 1106, 1108. In this manner, any serialization and/or prioritization of data may be achieved in addition to coordinating multiple radio bearers. More particularly, a first virtual bearer 312, the streaming virtual bearer, can be the delay tolerant, interruption intolerant, virtual bearer described above. Other bearers, for other types of communications, could be included, such as a background bearer for transmitting large background blocks, or a real time bearer for delay intolerant communications. The common interface layers can be operated to prioritize data flow and traffic data to the logic link controller according to their relative priority and the needs of the application associated with the data. This multiple bearer component may be used with or without the bi-pass 314.

Thus it can be seen that the present invention can be applied to the existing GPRS/EDGE architectural and i) provide the operator with a commercially useful feature and ii) provide the network and mobile station manufacturing industry with a relatively low-risk, rapid method of the introducing the feature. The additional possibility for incorporating the “conversational” or real time bearer extension is also suggested. In the case of adding a real time bearer to the protocol, the functionality of RLC and MAC would both be completely bypassed, as the requirements for best efforts user data and real time data services are vastly different. The RLC/MAC functionality customized for real time conversational services then replaced by the “real time bearer” extension, then “tunneled” into the physical layer, possibly into a Flexible Layer One Concept (FLOC) component.

It is envisioned that if any virtual bearer operates on LLC frames transmitted in transparent mode, then the existing RLC transparent mode may be used. If the virtual bearer operates on radio blocks, then it may be architecturally simpler to create a separate bearer component that would be introduced into the existing RLC component. Additionally, the addition of any virtual bearer would likely have significant impact on the buffering of data between components within both the mobile and the network. In the case of the network, backhaul capacity should be taken into consideration as well. Further, isolating the influence of a feature to a single component is generally a non-trivial task, and may not even be possible for certain types of features. Part of the decision to utilize this type of architectural direction should be based on appropriateness.

It is also envision that the virtual bearer could be inserted in the network. If inserted in the network, this component would likely be confined to the Protocol Control Unit (PCU).

According to yet another aspect of the invention, a method and apparatus i) permit the network to set and adjust thresholds that control when and how the mobile reselects a cell, ii) enable the mobile to predict the likelihood of cell reselection and iii) enable the mobile to notify the network when a reselection is highly likely during the course of a packet data transmission, which in turn enables the network to take appropriate action in the assignment of a new cell on which to continue packet data interchange. Such reselection may be commanded within a network having a single air interface, or between heterogeneous air interfaces, e.g. GSM and UMTS.

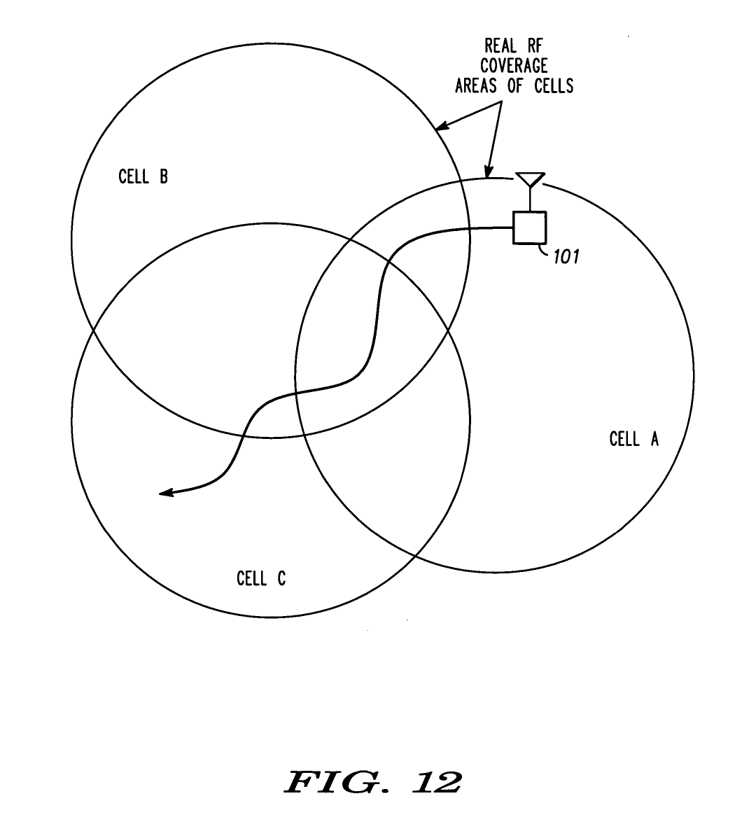

FIG. 12 illustrates a general mobile environment wherein cell reselection prediction can be advantageously employed. The mobile 101 is traveling through cells A, B, and C. In the illustration, the following events transpire. Packet data transmission is initiated in Cell A. The mobile reselects to cell B, aborting packet transfer with cell A (break-before-make). The mobile attempts to access cell B, but is denied access. The mobile 101 then reselects to cell C. The mobile successfully accesses cell C, performs routing area update, and continues with packet data transfer.

The ability to predict a cell change would be advantageous for the following reasons. First, if the virtual bearer described hereinabove is employed in the mobile, the operation of the virtual bearer can be adjusted to accommodate the impending cell change. Second, regardless of whether the virtual bearer is employed, the network can determine in advance whether cell B has capacity to serve the mobile and whether cell C supported acceptable RF parameters for communication with the mobile, and responsive thereto, communicate with the mobile directly to direct the mobile 101 to cell C prior to the break, thereby minimizing the data interruption.

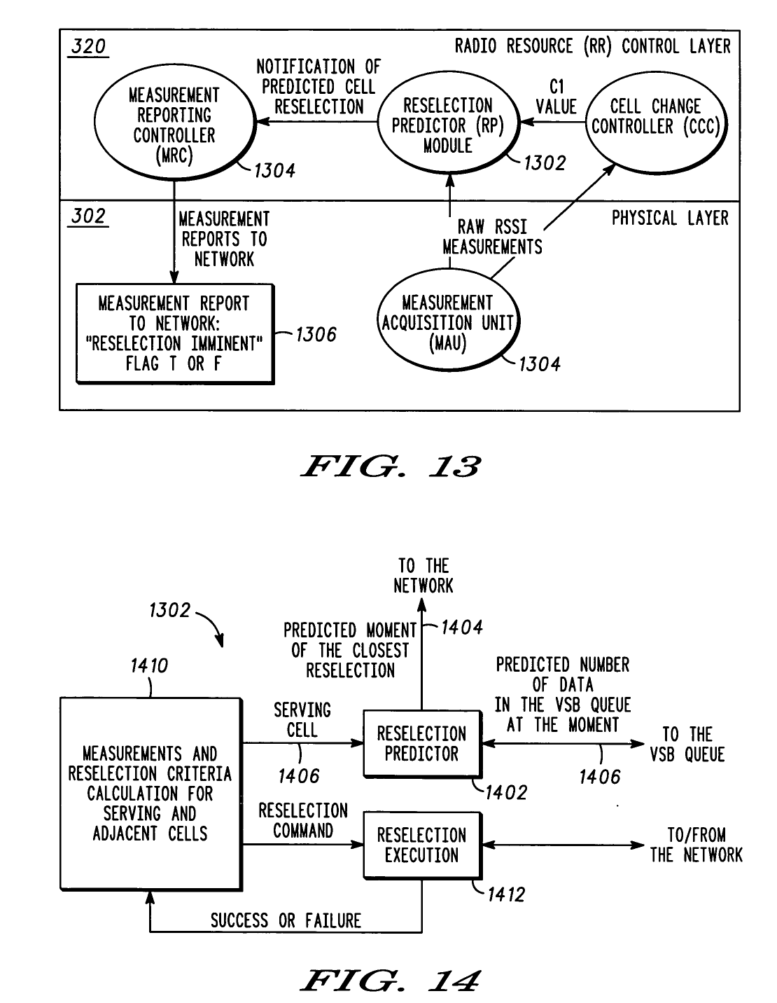

FIG. 13 illustrates a portion of the mobile 101. The reselection predictor 1302 is in the radio resource layer of the mobile 101. The resection predictor is coupled to receive received signal strength (RSSI) measurements from the measurement acquisition unit 1304 in the physical layer 302. The RSSI measurements are also provided to the cell change controller (CCC), which performs existing mobile cell changes known in the art, such as the mobile cell change found in GSM specification 3GPP TS 05.08. The cell change controller outputs a value C1 to the reselection predictor module 1302. The reselection predictor generates an indication of the predicted cell reselection to the measurement reporting controller 1304, which reports the measurement to the network by setting a reselection imminent flag to True (T) 1306. Although the above is described with reference to the mobile 101, those skilled in that art will recognize that the logical locus of the proposed apparatus can be within the Radio Resource (RR) management layer of the mobile and/or the network.

Those skilled in the art will also recognize that the manner in which the mobile 101 shall perform measurements for the purpose of managing network controlled cell reselection, as well as how the mobile shall perform measurements for normal cell reselection, are known. The manner and rules for the mobile to follow in order to select, reselect a cell in idle mode, and also packet transfer mode, operation are known. These rules are implemented in the radio resource layer, along with support in the physical layer referred to as the Cell Change Controller, (CCC). This existing set of logic that performs the measurements are referred to as a Measurement Acquisition Unit, (MAU) 1304 and the set of logic that reports the measurements from the mobile to the network may be referred to as the Measurement Reporting Controller (MRC) 1304.

One improvement to the existing components of a mobile cell reselection logic adds an additional component resident in the radio resource, referred to herein as the Reselection Predictor (RP) module. This new component receives its input primarily from the cell change controller module and sends its output primarily to the measuring reporting controller. The purpose of the reselection predictor is to i) analyze pre-processed measurements sent to the CCC from the MAU and ii) notify the network via the MRC.

The structure of cell reselection is illustrated in FIG. 14. The reselection predictor 1402 has one logical input 1408, and a first possible output 1404 comprising a “warning” to the network that reselection is predicted by setting “reselection imminent” bit in an uplink measurement report, and a second possible output 1406 in the form of an indication to the virtual bearer (VB), which may for example be a virtual streaming bearer (VSB), that reselection is predicted. Either output 1404 or 1406 can be provided in the alternative, or they may both be provided. The reselection predictor has as its logical input 1408 an output of the measurement acquisition module 1410. The reselection predictor receives C1 measurements (RSSI) as an input from the measurement module 1410 of the cell change controller. Reselection execution 1412 occurs when the cell change controller determines that reselection must occur, which may be determined by the network or the mobile.

In one embodiment, the mobile station architecture includes a reselection predictor that predicts when reselection is likely to occur. In the exemplary implementation of FIG. 14, the reselection predictor 1302 receives Cl parameter values, which are calculated based on RSSI measurements, at an input 1406 from a measurement module 1410. The C1 parameter value is exemplified herein, but other criteria may be used alternatively.

The reselection predictor includes an output 1404 for indicating when reselection is likely to occur. In one embodiment, for example, the mobile station sets a “reselection” bit in an uplink measurement report sent to the network to notify the network of the impending reselection based upon the output of the reselection predictor. The exemplary reselection predictor also includes a second output 1406 for indicating to a virtual bearer (VB), for example, a virtual streaming bearer (VSB), or some other module on the mobile station that reselection is imminent. The outputs 1404 and 1406 may be provided in the alternative, or both outputs may be provided.

In FIG. 14, reselection is performed by a reselection execution module 1412 on the mobile station in response to a reselection command when reselection is required. The reselection command may result from a determination made at the network or at the mobile station, as discussed more fully below.

In one embodiment, generally, reselection is predicted based upon reselection criteria, RC, computed from a set of several curves fit to approximate corresponding sets C1 parameter values, and based upon coefficients of the curve. In the exemplary embodiment, the parabolic curves approximate a set of several yᵢ=C1 parameter values, which are based on corresponding RSSI measurements acquired at time tᵢ. Curve coefficients a₀, a₁ and a₂ are computed as a function of yᵢ and tᵢ using a minimum least squares method based upon a corresponding set of C1 parameter values. In FIG. 15, each parabolic curve is computed to approximate 5 C1 parameter values. For each new C1 parameter value, a new set of parabolic curve coefficients is generated to approximate the 5 most recent C1 parameter values. In FIG. 15, the first parabolic curve is based upon C1 values at times tᵢ through tᵢ₊₄, the next parabolic curve is based upon C1 values at times tᵢ₊₁ through tᵢ₊₅, and the next parabolic curve is based upon C1 values at times tᵢ₊₂ through tᵢ₊₆, etc. For each parabolic curve, a reselection criterion, RC, is computed at the time corresponding to last C1 value using the relation RC=a₀+a₁tₙ+a₂tₙ². Several reselection criteria, RC, points are illustrated in FIG. 15.

An exemplary algorithm for the reselection predictor starts the n-points sliding parabola calculation by finding required initial sums based on the first yⱼ, where yⱼ is the C1 parameter value from the GSM 3GPP standards discussed above, reselection criteria values at the corresponding moments tⱼ:

$${S}_{t0} = {\sum }_{j = 1}^{n} {t}_{j} ; {S}_{tt0} = {\sum }_{j = 1}^{n} {t}_{j} {t}_{j} ; {S}_{ttt0} = {\sum }_{j = 1}^{n} {t}_{j} {t}_{j} {t}_{j} ; {S}_{tttt0} = {\sum }_{j = 1}^{n} {t}_{j} {t}_{j} {t}_{j} {t}_{j} ; {S}_{y0} = {\sum }_{j = 1}^{n} {y}_{j} ; {S}_{ty0} = {\sum }_{j = 1}^{n} {t}_{j} {y}_{j} ; {S}_{tty0} = {\sum }_{j = 1}^{n} {t}_{j} {t}_{j} {y}_{j} ;$$

The reselection criteria calculation is based on raw RSSI measurements separated in time by an interval ΔT.

The following calculations are performed starting with initialization of i=1.

BEGIN

RSSIi=get_RSSI_measurements(ti);

yᵢ=calculate_reselection_criteria(RSSIi);

//Current sums based on the previous ones

B=Sₜ₍ᵢ₎=Sₜ₍ᵢ₋₁₎−tᵢ₋₁+tᵢ;

C=Sₜₜ₍ᵢ₎=Sₜₜ₍ᵢ₋₁₎−tᵢ₋₁tᵢ₋₁+tᵢtᵢ;

F=Sₜₜₜ₍ᵢ₎=Sₜₜₜ₍ᵢ₋₁₎−tᵢ₋₁tᵢ₋₁tᵢ₋₁+tᵢtᵢtᵢ;

M=Sₜₜₜ₍ᵢ₎=Sₜₜₜₜ₍ᵢ₋₁₎−tᵢ₋₁tᵢ₋₁tᵢ₋₁tᵢ₋₁+tᵢtᵢtᵢtᵢ;

P=S_{y(i)}=S_{y(i-1)}−yᵢ₋₁+yᵢ;

R=S_{ty(i)}=S_{ty(i-1)}−tᵢ₋₁yᵢ₋₁tᵢyᵢ;

S=S_{tty(i)}=S_{tty(i-1)}−tᵢ₋₁tᵢ₋₁yᵢ₋₁+tᵢtᵢyᵢ;

//Auxiliary parameters

D=Sₜ₍ᵢ₎;

E=Sₜₜ₍ᵢ₎;

K=Sₜₜ₍ᵢ₎;

L=Sₜₜ₍ᵢ₎;

Q=D/n;

E=E−QB;

F=F−QC;

R=R−QP;

Q=K/n;

L=L−QB;

M=M−QC;

S=S−QP;

Q=L/E;

//Coefficients of the sliding parabola ending at the moment tₙ

a₂=(S−RQ)/(M−FQ);

a₁=(R−Fa₂)/E;

a₀=(P−Ba₁−Ca₂)/n;

//Reselection criteria at the moment tₙ calculated based on //approximation

RC(tₙ)=a₀+a₁tₙ+a₂tₙ²

i=i+1;

END

FIG. 16 is a graphical illustration of the reselection criteria RC, and coefficients a₀, a₁, and a₂. Reselection is determined to be imminent when RC values evaluated at endpoints of several sequential curves are descending, and when the coefficients a₀, a₁, and a₂ for at least some of the several sequential curves satisfy conditions indicative of an impending reselection, as discussed more fully below. In one embodiment, when reselection is imminent, the estimated time at which cell reselection occurs is determined by the relation Tᵣ=−a₀(T_{d})/a₁(T_{d}). The point in time T_{d} is when a potential reselection has been detected, and T_{c}=T_{d}+mΔT is a current moment of time. In one embodiment, when m=3, reselection is predicted as follows:

IF

0<RC(T_{c})<RC(T_{c}−ΔT)<RC(T_{c}−2ΔT)<RC(T_{d}=T_{c}−3ΔT)

AND

a₀(T_{d})>0ANDa₁(T_{d})<0ANDsign[a₂ (T_{d}−ΔT)]<0ANDsign[a₂ (T_{d}+ΔT)]>0

AND

sign[a₀(T_{c})]>0ANDsign[a₁(T_{c})]<0

THEN,

the cell reselection predicted time is

Tᵣ=−a₀(T_{d})/a₁(T_{d}).

The reselection predictor may run continuously during a connection. Each time the conditions for predicting a reselection are satisfied, Tᵣ will be updated. When reselection conditions are no longer met, cell reselection will not be predicted.

Alternatively, the reselection prediction algorithm according to another embodiment uses the following steps:

| | |
|---|---|
| Step 1 | First acquire n RSSI measurements, where n > 2 |
| Step 2 | Acquire RSSI measurement at moment of time ti |
| Step 3 | Compute yi = C1 reselection criterion as per 3GPP TS |
| | 05.08, clause 6.4, for entire n set of RSSI measurements. |
| Step 4 | Compute a₀, a₁, and a₂ as a function of yi and ti using minimum |
| | least square method based on previous n |
| | measurements, where n > 3. |
| Step 5 | Compute predicted RC based on a₀, a₁ and a₂ at last |
| | moment n, i.e. RC = a₀ + a1tn + a2tntn |
| Step 6 | determine IF a₀, a₁ and a₂ have predetermined relationship |
| | and is slope RC downward for 3 consecutive samples AND |
| Step 6 | IF a₀ for current period T_{d} is positive, AND |
| Step 7 | a₁ for current period T_{d} is negative, AND |
| Step 8 | IF a₂ changes sign from negative as previous period to |
| | positive at current period T_{d}, AND |
| Step 9 | IF predicted parabola RC slope beginning at current period |
| | T_{d} is descending for minimum of 3 periods, AND |
| Step 10 | IF sign of a₀ at last point at which RC was predicted is |
| | positive, AND |
| Step 11 | IF sign of a1 at last point at which RC was predicted is |
| | negative, THEN |
| Step 12 | Cell reselection is deemed to be imminent and its time into |
| | the future is calculated to be Tᵣ = −a₀(T_{d})/a₁(T_{d}) |
| Step 13 | Increment I time interval |
| Step 14 | Jump to step 2. |

Every predefined period of time ΔT, RP receives the serving cell RSSI measurements from the measurements module. As it mentioned above, the mobile station performs RSSI measurements every TDMA frame (4.615 ms) being in TBF mode. The period of time ΔT can be estimated as approximately 100 TDMA frames.

Upon receiving the new measurement, the RP module calculates one of the reselection criteria RC. C1 is exemplified herein, but the invention will find application with other reselection criteria, and in standards other than GSM and its progeny.

Based on the previous n reselection criteria (for eaxmple, n can be assigned value of 5), the RP approximates RCs values with the parabolic curve using formula

RC(t)=a₀+a₁t+a₂t²

Parameters a₀, a₁ and a₂ are defined with the Minimum Least Square (MLS) method. The idea of the “running parabola” approximation is graphically represented in FIG. 15.

The above detailed description of the invention and the examples described therein have been presented for the purposes of illustration and description. While the principles of the invention have been described above in connection with a specific device, it is to be clearly understood that this description is made only by way of example and not as a limitation on the scope of the invention.

1. A method of operating a mobile communication device, comprising the steps of:
transmitting over-the-air that a virtual bearer mode of operation is supported;
receiving a response; and
selectively operating in a virtual bearer mode depending upon the response.

2. The method according to claim 1, wherein the mobile device includes a first controller maintaining the integrity of the radio link and a second controller converting between over-the-air and internal forms, and wherein said step of selectively operating includes communicating between the first controller and the second controller via a virtual bearer in the virtual mode and communicating between the first controller and the second controller independently of the virtual bearer in a transparent mode.

3. The method according to claim 1, wherein the virtual bearer mode is initiated in response to a response indicating a streaming bearer will be

4. A mobile communication device, comprising:
a radio link controller coupled to lower layers;
a virtual bearer including a buffer storing at least one logical link controller frame of a communication signal; and
a logical link controller coupled to the virtual bearer for receiving logical link controller frames from the logical link controller;
wherein the virtual bearer is operative to apply flow control to the lower layers in order to maintain a predetermined queue state target.

5. A mobile communication device, comprising:
a radio link controller coupled to lower layers;
a virtual bearer including a buffer storing at least one logical link controller frame of a communication signal; and
a logical link controller coupled to the virtual bearer for receiving logical link controller frames there from;
wherein the virtual bearer is operative to apply flow control to the lower layers and is responsive to a determination that a cell change is imminent.

6. The mobile communication device as defined in claim 5, wherein the determination is received from a network.

7. The mobile communication device as defined in claim 5, wherein the determination is made by the mobile.

8. The mobile communication device as defined in claim 7, wherein the determination is made using a predictive algorithm.

9. A method of operating a communication system including a network element, comprising the steps of:
determining that a virtual bearer is required on the downlink; and
transmitting the virtual bearer type.

10. The method of claim 9, wherein the step of transmitting includes transmitting an indication of a streaming bearer type for streaming data.

11. The method of claim 9, wherein the step of transmitting includes transmitting an indication of background bearer type for background data transmission.

12. The method of claim 9, wherein the step of transmitting includes transmitting an indication of no virtual bearer for interactive data.

13. The method of claim 10, further including the step of over-dimensioning the downlink signal to accommodate cell change by the mobile during a streaming bearer type of virtual bearer mode of operation.

14. A method of operating a communication system including a network element, comprising the steps of:
determining that a virtual bearer is required on the downlink; and
over-dimensioning the downlink signal to accommodate a cell change by the mobile during a virtual bearer mode of operation.

15. The method of claim 14, further including the step of not over-dimensioning the downlink signal to accommodate a cell change by the mobile during a background bearer type of virtual bearer mode operation.

16. A method of operating a mobile communication device, comprising:
storing at least one frame of a communication signal received from a network; and
applying flow control to the lower layers in a virtual bearer responsive to a determination that a cell change is imminent.

17. A method of operating a mobile communication device, comprising:
receiving a downlink streaming signal at a first data rate; and
outputting the signal at a slower rate during at least a portion of the transmission.
